(19) United States
(12) Patent Application Publication
(10) Pub. No.: US 2009/0078549 A1
(43) Pub. Date: Mar. 26, 2009

(54) AUXILIARY ACTUATING DEVICE FOR AN ELECTROMECHANICAL SWITCHING DEVICE

(75) Inventor: Walter Gilgen, Koenigswinter (DE)

Correspondence Address: DARBY & DARBY P.C., P.O. BOX 770, Church Street Station, New York, NY, 10008-0770, US

(73) Assignee: Moeller GmbH, Bonn (DE)

(21) Appl. No.: 12/211,597

(22) Filed: Sep. 16, 2008

(30) Foreign Application Priority Data
Sep. 20, 2007 (DE) 20 2007 013 185.2

(51) Int. Cl. H01H 3/20

(52) U.S. Cl. 200/330

(57) ABSTRACT

An auxiliary actuating device for an electromechanical switching device. The actuating device including a handle housing rotatably disposed on an actuating shaft coupled to the switching device and engageably coupled to a door coupling handle, an exterior having at least one handle element, and an interior having a plurality of first coupling elements. The actuating device further including a coupling wheel rigidly connected to the actuating shaft and received in the handle housing, the coupling wheel having a plurality of second coupling elements and a spring element to act between the handle housing and the coupling wheel. Further, the first and second coupling elements engage with each other through a displacement against a force of the spring element, the housing is bendable, and the handle hosing includes locking hooks configured to snappedly secure the coupling wheel in the housing, and limit an axial displacement of the housing.

### CROSS REFERENCE TO PRIOR APPLICATIONS

Priority is claimed to German Patent Application No. 20 2007 013 185.2, filed Sep. 20, 2007, the entire disclosure of which is incorporated by reference herein.

### FIELD

The present invention relates to an auxiliary actuating device for an electromechanical switching device arranged about an actuating shaft coupled to a switching operator of the switching device and engageably coupled to a door coupling handing, and in particular to a power switch which is installed in lockable switchgear.

### BACKGROUND

A conventional auxiliary actuating device, which on the one hand is connected to an electromechanical switching device mounted in a switch cabinet, and which on the other hand is engaged, when the switch cabinet door is closed, with a door coupling turning handle which is to be actuated from the outside, is described in U.S. Pat. No. 7,071,427 B2. When the switch cabinet door is opened the auxiliary actuating device disengages from the door coupling turning handle. The auxiliary actuating device includes a handle housing, which is formed with handle elements and which is disposed so as to be rotatable and displaceable in an axially limited manner about an actuating shaft, which on the one hand is connected to a switch operator of the switching device and which on the other hand can be brought into engagement with the door coupling handle when the switch cabinet door is closed. A polygonal ratchet wheel is disposed inside the handle housing on the actuating shaft so as to be rotatable and displaceable in an axially limited manner and forms, together with first ribs which are axially aligned on the inner wall of the handle housing, a unidirectional swivel coupling. This unidirectional swivel coupling causes the rotational movement to be transferred to the actuating shaft only when the turning handle is simply turned in one of the two directions of rotation, and no transfer of movement occurs in the other case. Thus, the switching movement carried out by means of the handle housing is effective only in one direction, preferably in the direction for switching off the switching device. A coupling wheel is further arranged inside the handle housing so as to be displaceable in an axially limited manner but to be rotationally engaged on the actuating shaft and is equipped at its periphery with axially aligned second ribs. A coil spring is supported between the coupling wheel and the ratchet wheel and acts on the coupling wheel in the direction away from the switching device relative to the handle housing, the coupling wheel resting on an annular housing part, which is formed with handle elements and which is screwed onto the handle housing on its end face. In this state, it is only possible to the transfer the rotational movement from the handle housing via the unidirectional swivel coupling. Engagement of the door coupling handle when the switch cabinet door is being closed, or a pull on the handle housing when the switch cabinet is open displaces the coupling wheel in the axial direction relative to the handle housing, against the spring force of the coil spring, causing the second ribs of the coupling wheel to reach between the first ribs in the handle housing. In this state, a transfer of movement takes place in both directions of rotation of the handle housing relative to the actuating shaft. This bidirectional movement transfer now allows a switching movement in both directions to be achieved, i.e. both for switching off and for switching on the switching device. A disadvantage of this auxiliary actuating device is the complexity of manufacture and the great expense of the construction thereof.

### SUMMARY

An aspect of the present invention provides an inexpensive construction of an auxiliary actuating device which does not allow unintentional transfer of the rotational movement.

An embodiment of the present invention provides an auxiliary actuating device for an electromechanical switching device. The actuating device includes a handle housing rotatably disposed on an actuating shaft coupled to a switching operator of the switching device and engageably coupled to a door coupling handle, an exterior of the handle housing having at least one external handle element, and an interior of the handle housing having a plurality of evenly spaced axially extending first coupling elements. The actuating device further includes a coupling wheel rigidly connected to the actuating shaft and received in the handle housing, the coupling wheel having a plurality of evenly spaced axially extending second coupling elements and a spring element configured to act between the handle housing and the coupling wheel so as to disengage the first and second coupling elements. Further, the first and second coupling elements are configured to engage with each other through an axial displacement of the handle housing relative to the coupling wheel against a force of the spring element, the handle housing is bendable in a radial direction towards an edge of the coupling wheel, and the handle housing includes locking hooks configured to snappedly secure the coupling wheel in the handle housing, and limit an axial displacement of the handle housing relative to the coupling wheel.

### BRIEF DESCRIPTION OF THE DRAWINGS

FIG. 1 is a perspective view of an embodiment of the auxiliary actuating device according to the present invention;

FIG. 2 is an exploded, partially sectional view, somewhat enlarged by comparison with FIG. 1, of an embodiment according to the present invention; and

FIG. 3 is a perspective view of another embodiment of the auxiliary actuating device according to the present invention.

### DETAILED DESCRIPTION

A simple assembly of the auxiliary actuating device and an inexpensive and effective delimitation of the relative displacement of the handle housing and the coupling wheel are achieved with a small number of components by means of the coupling wheel, which is rigidly connected to the actuating shaft, and the inclined locking hooks on the handle housing. When the door of the switching installation is closed, a rotational movement of the door coupling handle is transferred directly to the actuating shaft in both directions of rotation. When the door is open, no transfer of movement to the actuating shaft can take place in either direction merely by carrying out a rotational movement. Transfer of movement from the handle housing to the actuating shaft in the two directions of rotation is effected only by means of an intentional displacement of the handle housing relative to the coupling wheel by applying force.

An arrangement which leaves a distance between the outline-fitted first and second coupling elements is of further advantage. This reduces the number of available coupling positions between the handle housing and the coupling wheel over a full rotation, and this focuses the attention and thus the awareness of the operator in the desired manner in carrying out a switching movement when the switchgear is open. The coupling elements are expediently formed as ribs and grooves.

According to an aspect of the present invention, the coupling wheel is closer to the door coupling handle than to the switching device by comparison with the handle housing, and the spring element exerts a compression force between the handle housing and the door coupling handle, or according to another aspect of the present invention the coupling wheel is closer to the switching device than to the door coupling handle by comparison with the handle housing, and the spring element exerts a tensile force between the handle housing and the door coupling handle, then when the switchgear is open, the handle housing is brought into a coupling engagement with the coupling wheel by a pulling movement away from the switching device.

By contrast, if, on the one hand, the coupling wheel is closer to the door coupling handle than to the switching device by comparison with the handle housing, and the spring element exerts a tensile force between the handle housing and the door coupling handle, or if, on the other hand, the coupling wheel is closer to the switching device than to the door coupling handle by comparison with the handle housing, and the spring element exerts a compression force between the handle housing and the door coupling handle, then when the switchgear is open, the handle housing is brought into a coupling engagement with the coupling wheel by a pushing movement towards the switching device.

For a simpler assembly, the coupling wheel is substantially disc-shaped and/or the handle housing is formed substantially in the shape of a pot.

The handle elements are advantageously formed as cylindrical handle beads or as outwardly projecting handle levers. The former save space and are preferentially suited to switching devices with a small construction, whilst the latter, because of the better force transfer, are better suited to switching devices of a larger construction.

It is expedient for the spring element which is supported between the handle housing and the coupling wheel to be formed as a coil spring, through the central axis of which the actuating shaft extends.

Further features and advantages of the present invention will emerge from the following embodiments which are explained by way of the figures, in which:

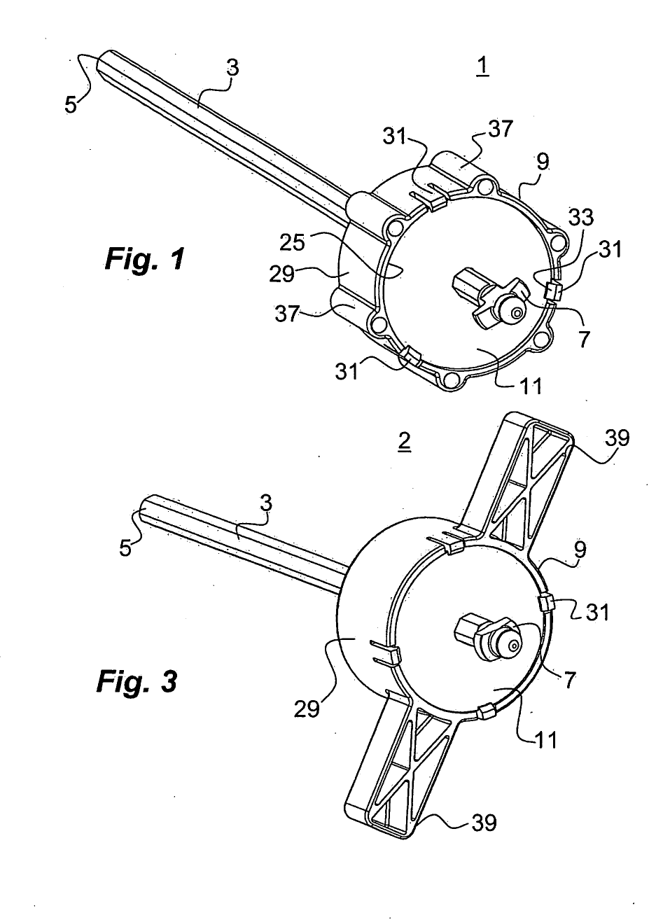

The auxiliary actuating device 1 shown in FIG. 1 is arranged with the central axis thereof about an actuating shaft 3. The actuating shaft 3 is connected via the rear, blunt shaft end 5 thereof to a switch operator of an electrical switching device mounted in switchgear, for example of a power switch mounted in a switch cabinet. The actuating shaft 3 is equipped, at the front end thereof, with a T-shaped engagement piece 7 for positive engagement in a door coupling handle, which passes through a door of the otherwise closed switchgear. The arrangement of the switching device and the auxiliary actuating device inside switchgear, and of the door coupling handle which is disposed in the door of the switchgear, may be as described in the previously cited U.S. Pat. No. 7,071,427 B2, which is incorporated by reference herein (in which see in particular FIG. 3). The auxiliary actuating device 1 includes a pot-shaped handle housing 9 and a disc-shaped coupling wheel 11 which is arranged in the housing.

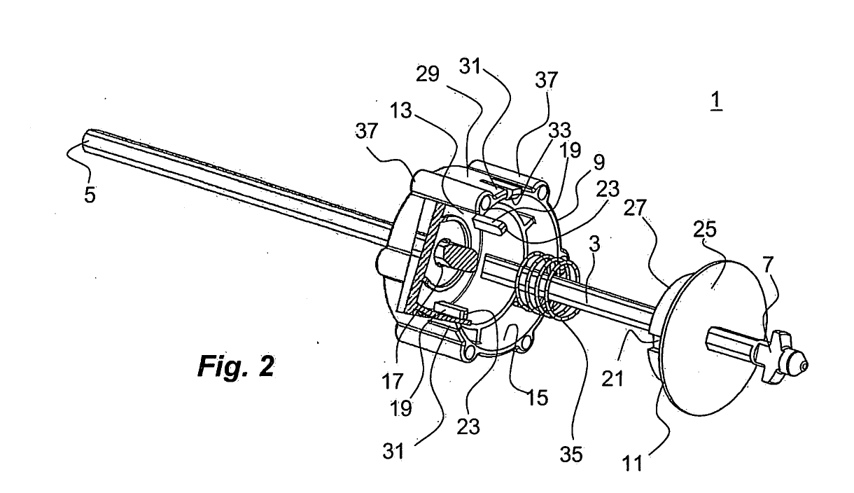

As is shown in FIG. 2, the handle housing 9, which is formed in one part, includes a rear end wall 13, which is directed towards the shaft end 5, and a cylindrical inner wall 15 which locks onto said end wall. The end wall 13 is provided with a circular aperture 17, of which the internal diameter is selected in relation to the actuating shaft 3 in such a way that the handle housing 9 can be displaced and rotated freely on said actuating shaft 3. First coupling elements 19, which extend in the axial direction, are integrally formed on the inner wall 15 at the same angular distance in relation to the actuating shaft 3. In the example, three first coupling elements 19 are provided, of which only two can be seen in the drawing. The rib-shaped first coupling elements 19 are thus separated from one another at a considerable angle. The first coupling elements 19 are provided on the end face, facing towards the coupling wheel 11, with chamfers 23.

The coupling wheel 11, which is formed in one piece, is equipped with an end plate 25, to which a cylindrical coupling disc 27 is attached so as to be set back from said plate and facing away from the engagement piece 7. Second coupling elements 21, which are arranged cylindrically and extend in the axial direction, are formed at the same angular distance with respect to the actuating shaft 3 on the edge of the coupling disc 27. In the example, three second coupling elements 21 are provided, of which only one can be seen in the drawing. The groove-shaped second coupling elements 21 of the coupling wheel 11 are thus separated from one another at the same angle as the first coupling elements 19 of the handle housing 9. The first and the second coupling elements 19 and 21 have outer and inner contours respectively which are fitted to one another. The coupling wheel 11 is connected to the actuating shaft 3 in such a way that said wheel can neither rotate nor be displaced. A weld, press fitting, adhesive bond or screw connection, for example, can provide a suitable connection means.

Evenly distributed locking hooks 31 are provided along the circumference of the outer wall 29 in the region of the cylindrical outer wall 29, which extends into the open, of the handle housing 9. The resilient locking hooks 31, which extend in the axial direction, can be bent outwards radially relative to the central axis of the handle housing 3 and have inwardly inclined introduction chamfers 33 at the end. In the construction of the auxiliary actuating device 1, a spring element 35 in the form of a coil spring is slid over the shaft end 5 of the actuating shaft 3, which is connected to the coupling wheel 11, whereupon the handle housing 9, by means of the aperture thereof, is brought over the actuating shaft 3 in such a way that the locking hooks 31 are disposed opposite the coupling wheel 11. For the assembly of the auxiliary actuating device 1, the handle housing 9 is slid, by means of the introduction chamfers 33 of the locking hooks 31 thereof, over the edge of the end plate 25, until the locking hooks 31 snap over the end plate 31. In this way the handle housing 9 is connected to the coupling wheel 11 so as to be displaceable in an axially limited manner.

Handle elements, which are evenly distributed over the circumference and which extend in the axial direction, are provided in the form of cylindrical handle beads 37 on the outer wall 29 of the handle housing 9. The spring element 35 is supported between the inner end wall 13 of the handle housing 9 and the coupling disc 27 of the coupling wheel 11, and this means that in the state where the auxiliary actuating device 1 is not acted upon from the outside, the end plate 25 directly abuts the locking hooks 31, as is shown in FIG. 1. In this state, no engagement occurs between the first and the second coupling elements 19 and 21, in such a way that a rotational movement applied to the handle housing 9, both in one direction and in the opposite direction, is not transferred to the coupling wheel 11 and thus is also not transferred to the actuating shaft 3 so as to switch on or off the switching device. When the door of the switchgear is closed, however, the provided door coupling handle overlaps the engagement piece 7 in such a way that a rotational movement which is applied to the door coupling handle both in one direction and in the opposite direction, is now transferred directly to the switching device via the actuating shaft 3.

If the switching device is intentionally switched by an operator when the door of the switchgear is open, then the handle housing 9 is to be pulled away from the switching device against the force of the spring element 35, and optionally, the coupling elements 19, 21 are to be brought into engagement by a simultaneous rotational movement. With a rotational coupling, which is produced in this manner, between the handle housing 9 and the coupling wheel 11, a rotational movement which is applied to the handle housing 9, both in one direction and in the opposite direction, is transferred to the coupling wheel 11 by means of the coupling elements 19, 21, and thus to the switching device via the actuating shaft 3.

FIG. 3 shows an auxiliary actuating device 2, which is intended for larger switching devices than the auxiliary actuating device 1 shown in FIG. 1, and which conventionally can require a greater application of force for switching. For this purpose, two opposed handle elements are formed on the outer wall 29 of the handle housing 9 in the form of radially protruding handle levers 39. Otherwise, the auxiliary actuating device 2 is constructed in the same way as the auxiliary actuating device 1 according to FIG. 1, and has the same functionality.

In the embodiments disclosed above, it is assumed that the coupling wheel 11, by comparison with the handle housing 9, is closer to the engagement piece 7 of the actuating shaft 3, and the spring element 35 exerts a compression force between the handle housing 9 and the coupling wheel 11, which means that a pull on the handle housing 9 achieves bidirectional rotational coupling. However, the present invention is not limited to this embodiment. It is thus within the scope of the present invention for the coupling wheel 11, by comparison with the handle housing 9, to be closer to the shaft end 5 of the actuating shaft 3 and/or for the spring element 35 to exert a tensile force between the handle housing 9 and the coupling wheel 11. This results, according to the selection of one of the above combinations, in a pulling movement, or once again a pushing movement, on the handle housing 9 in order to achieve bidirectional rotational coupling.

The present invention is not limited to the embodiments described herein; reference should be had to the appended claims.

### LIST REFERENCE NUMERALS

1; 2 auxiliary actuating device
3 actuating shaft
4 shaft end
7 engagement piece
8 handle housing
11 coupling wheel
12 end wall
15 inner wall
16 aperture
19; 21 coupling elements
23 chamfer
24 end plate
27 coupling disc
28 outer wall
31 locking hooks
32 introduction chamfer
35 spring element
36 handle bead
39 handle lever

1: An auxiliary actuating device for an electromechanical switching device, the actuating device comprising:
a handle housing rotatably disposed on an actuating shaft coupled to a switching operator of the switching device and engageably coupled to a door coupling handle, an exterior of the handle housing having at least one external handle element, and an interior of the handle housing having a plurality of evenly spaced axially extending first coupling elements;
a coupling wheel rigidly connected to the actuating shaft and received in the handle housing, the coupling wheel having a plurality of evenly spaced axially extending second coupling elements; and
a spring element configured to act between the handle housing and the coupling wheel so as to disengage the first and second coupling elements;
wherein the first and second coupling elements are configured to engage with each other through an axial displacement of the handle housing relative to the coupling wheel against a force of the spring element,
wherein the handle housing is bendable in a radial direction towards an edge of the coupling wheel, and
wherein the handle housing includes locking hooks configured to snappedly secure the coupling wheel in the handle housing and limit an axial displacement of the handle housing relative to the coupling wheel.

2. The auxiliary actuating device as recited in claim 1, wherein the first and the second coupling elements include mutually corresponding contours and are respectively disposed at a tangential distance from each other.

3. The auxiliary actuating device as recited in claim 1, wherein the first coupling elements include ribs and the second coupling elements include grooves.

4. The auxiliary actuating device as recited in claim 1, wherein the first coupling elements include grooves and the second coupling elements include ribs.

5. The auxiliary actuating device as recited in claim 1, wherein the coupling wheel is received in the handle housing facing away from the switching device, and the force of the spring element acts upon the handle housing in a direction towards the switching device relative to the coupling wheel.

6. The auxiliary actuating device as recited in claim 1, wherein the coupling wheel is received in the handle housing facing towards the switching device, and the force of the spring element acts upon the handle housing in a direction towards the switching device relative to the coupling wheel.

7. The auxiliary actuating device as recited in claim 1, wherein the coupling wheel is received in the handle housing facing away from the switching device, and the force of the spring element acts upon the handle housing in a direction away from the switching device relative to the coupling wheel.

8. The auxiliary actuating device as recited in claim 1, wherein the coupling wheel is received in the handle housing facing towards the switching device, and the force of the spring element acts upon the handle housing in a direction away from the switching device relative to the coupling wheel.

9. The auxiliary actuating device as recited in claim 1, wherein the coupling wheel is disc-shaped.

10. The auxiliary actuating device as recited in claim 1, wherein the handle housing is pot-shaped.

11. The auxiliary actuating device as recited in claim 1, wherein the at least one external handle element includes evenly spaced cylindrical handle beads extending parallel to the actuating shaft.

12. The auxiliary actuating device as recited in claim 1, wherein the at least one external handle element includes radially projecting handle levers.

13. The auxiliary actuating device as recited in claim 1, wherein the spring element is a coil spring disposed on the actuating shaft.

14. The auxiliary actuating device as recited in claim 1, wherein the plurality of first coupling elements are circumferentially evenly spaced.

15. The auxiliary actuating device as recited in claim 1, wherein the plurality of second coupling elements are circumferentially evenly spaced.
